(19) United States
(12) Patent Application Publication
(10) Pub. No.: US 2026/0067815 A1
(43) Pub. Date: Mar. 5, 2026

(54) DEVICES, METHODS AND SYSTEM FOR LOW-POWER WAKE-UP SIGNALLING

(71) Applicant: HUAWEI TECHNOLOGIES CO., LTD., Shenzhen (CN)

(72) Inventors: Louis Madier, Boulogne Billancourt (FR); Yifan Xue, Beijing (CN)

(73) Assignee: HUAWEI TECHNOLOGIES CO., LTD., Shenzhen (CN)

(21) Appl. No.: 19/384,432

(22) Filed: Nov. 10, 2025

Related U.S. Application Data
(63) Continuation of application No. PCT/CN2023/113047, filed on Aug. 15, 2023.

(30) Foreign Application Priority Data
May 12, 2023 (WO) PCT/CN2023/093800

(51) Int. Cl. H04W 52/02; H04L 5/00; H04W 72/11

(52) U.S. Cl. CPC H04W 52/0235; H04L 5/0048; H04W 72/11

(57) ABSTRACT

The present disclosure relates to low-power wake-up signalling for wireless communications. A network device is configured to generate and send a low-power wake-up signal (LP-WUS) to one or more user devices. The LP-WUS comprises activation and/or deactivation information for activating or deactivating one or more resource allocations. In response to receiving the LP-WUS, a user device in a power-saving mode (or sleeping mode) is configured to wake up, and activate or deactivate one or more resource allocations for communication. The resource allocations may be semi-persistently configured through semi-persistent scheduling (SPS). In this way, the coexistence of LP-WUS monitoring and pre-configured resource allocations (e.g., SPS assignments) are harmonized. The power consumption of the user device can be reduced, and traffic latency can be improved.

### CROSS-REFERENCE TO RELATED APPLICATIONS

This application is a continuation of International Application No. PCT/CN2023/113047, filed on Aug. 15, 2023, which claims priority to International Patent Application No. PCT/CN2023/093800, filed on May 12, 2023. The disclosures of the aforementioned applications are hereby incorporated by reference in their entireties.

### TECHNICAL FIELD

The present disclosure generally relates to the field of communications technology. For instance, the present disclosure provides devices, methods, and a system for low-power wake-up signalling.

### BACKGROUND

Power consumption is critical for wireless communications, especially for wearable and Internet-of-Things (IoT) devices. For optimizing power consumption, the 3rd Generation Partnership Project (3GPP) in New Radio (NR) release 15 supports user equipment (UE) connected mode discontinuous reception (CDRX), where the UE periodically monitors physical downlink control channel (PDCCH) during active time of CDRX using monitoring pattern(s) defined by the network. In 3GPP NR release 16, downlink control information (DCI) with CRC scrambled by PS-RNTI (DCP) is introduced to further optimize power consumption. To this end, DCI format 2_6 is introduced, and the UE monitors DCP outside the active time of CDRX. 3GPP NR standards release 17 supports scheduling DCI to indicate PDCCH skipping or search space set group (SSSG) switching. PDCCH skipping is used to indicate that the PDCCH is not monitored within a short period of time (i.e., skipping duration). SSSG switching indicates which SSSG should be used for PDCCH monitoring, such that the UE no longer needs to search the entire space.

For 3GPP NR release 18 and forward, a new mechanism called low-power wake-up signal (LP-WUS) is under study. When there is no traffic, a communications terminal may configure most of its components in the main radio into sleep mode and only power on its low-power wake-up receiver (LP-WUR or LP-WuRx). The LP-WUR consumes much less power than the main radio. The LP-WUS may be a dedicated signal designed to be detected by the LP-WUR, such that the communications terminal may be further configured to wake up its main radio for wireless communications. It is noted that the LP-WUS is different from the “WUS” indicated via DCI format 2_6. For instance, unlike the wake-up indication carried via DCI format 2_6, the LP-WUS may be transmitted via a dedicated channel and/or using dedicated modulation.

### SUMMARY

It still remains a question as to how to integrate the LP-WUS with other power-saving techniques in 3GPP NR. For instance, the content of the LP-WUS has not yet been defined. Further, it is also not clear how to reduce the latency when using the LP-WUS to wake up UEs in case of urgent traffic. Normally, when a UE (e.g., its wake-up receiver) detects the LP-WUS, the UE shall activate its main radio components. Then, the main radio starts to monitor PDCCH for UL/DL scheduling. However, this process is still long and can cause significant delays for latency-sensitive traffic such as ultra-reliable low-latency communications (URLLC) and extended reality (XR).

Semi-Persistent Scheduling (SPS) is configured by RRC signalling. SPS may be configured for a Serving Cell per BWP. Multiple assignments can be active simultaneously in the same BWP. Activation and deactivation of the SPS may be independent among the Serving Cells. For the DL SPS, a DL assignment is provided by PDCCH, and stored or cleared based on L1 signalling indicating SPS activation or deactivation. RRC signalling may configure the following parameters when SPS is configured:
cs-RNTI: CS-RNTI for activation, deactivation, and retransmission;
nrofHARQ-Processes: the number of configured HARQ processes for SPS;
harq-ProcID-Offset: Offset of HARQ process for SPS;
periodicity: periodicity of configured downlink assignment for SPS.

After a downlink assignment is configured for SPS, the MAC entity may consider sequentially that the Nth downlink assignment occurs in the slot for which:
(number_of_Slots_Per_Frame×SFN+slot number in the frame)=[(number_Of_Slots_Per_Frame×SFNstart time+slotstart time)+N×periodicity×number_Of_Slots_Per_Frame/10] modulo (1024×number_Of_Slots_Per_Frame),
where SFNstart time and slotstart time are the SFN and slot, respectively, of the first transmission of PDSCH where the configured downlink assignment was (re-)initialised.

When the SPS is released by upper layers, all the corresponding configurations shall be released.

It also still remains a question as to how to integrate the LP-WUS with pre-configured resource allocations such as SPS.

In view of the above-mentioned problems and disadvantages, the present disclosure aims to improve the mechanism of LP-WUS. For instance, an objective may be to reduce latency of using LP-WUS to wake up a communications terminal. A further objective may be to further optimize LP-WUS implementations such as LP-WUS monitoring coexistence with resource allocations such as SPS.

These and other objectives are achieved by this disclosure, for instance, as described in the independent claims. Advantageous implementations are further described in the dependent claims.

A first aspect of this disclosure provides a network device for wireless communications. The network device is configured to generate an LP-WUS. The LP-WUS comprises activation information or deactivation information for activating or deactivating one or more resource allocations. The network device is further configured to send the LP-WUS to one or more user devices.

In this disclosure, the activation information or deactivation information for activating or deactivating one or more resource allocations may be simply referred to as the (de-)activation information. It is noted that the activation information and the deactivation information for different user devices may be combined in the LP-WUS. That is, the LP-WUS may comprise activation information and/or deactivation information.

By sending the LP-WUS comprising the (de-)activation information, any UE receiving the LP-WUS can timely, e.g., upon receiving the LP-WUS, activate or deactivate the one or more resource allocations accordingly, without further signalling. That is, there is no signalling other than the LP-WUS involved for activating or deactivating the one or more resource allocations. In this way, the latency can be reduced.

In an implementation form of the first aspect, the network device may be further configured to activate or deactivate the one or more resource allocations according to the activation information or deactivation information.

Optionally, activating the one or more resource allocations may be referred to utilizing resources indicated by the one or more resource allocations for DL and/or UL communication with one or more UEs. Deactivating the one or more resource allocations may be referred to as not utilizing resources indicated by the one or more resource allocations.

It is noted that it is optional and not essential for the network device to activate or deactivate the one or more resource allocations according to the activation information or deactivation information, because there may be at least the following cases:
case 1: the network device is configured to send the LP-WUS and (de-)activate the one or more resource allocations accordingly;
case 2: a first network device (as the network device of the first aspect) is configured to send the LP-WUS, and a second network device is configured to (de-)activate the one or more resource allocations; and
case 3: the network device is configured to send the LP-WUS to a first UE, and a second UE is configured to (de-)activate the one or more resource allocations in order to communicate with the first UE.

In case 2, the first network device may be associated with a primary cell (PCell), and the second network device may be associated with a secondary cell (SCell). Case 3 may be applied to device-to-device (D2D) communications (e.g., vehicle to everything (V2X) communications), where the first UE and the second UE may directly communicate with each other.

In a further implementation form of the first aspect, the activation information or deactivation information may comprise flag information indicating whether a corresponding resource allocation is activated or deactivated for each user device.

Optionally, the flag information may comprise, for each user device, a flag indicating whether a corresponding resource allocation is activated or deactivated.

In a further implementation form of the first aspect, the activation information or deactivation information may comprise resource indication information indicating the one or more resource allocations to be activated or deactivated.

In a further implementation form of the first aspect, before generating the LP-WUS, the network device may be configured to send LP-WUS configuration information to the one or more user devices. The LP-WUS configuration information is indicative of one or more default resource allocations as the one or more resource allocations to be activated or deactivated.

That is, the one or more default resource allocations is to be activated or deactivated upon receiving the LP-WUS by default (e.g., when the LP-WUS does not comprise the resource indication information). If the LP-WUS comprises the resource indication information indicating one or more specific resource allocations to be activated or deactivated, then the one or more specific resource allocations override the one or more default resource allocations.

In a further implementation form of the first aspect, before generating the LP-WUS, the network device may be configured to send one or more resource configurations to the one or more user devices. Each resource configuration is indicative of a plurality of pre-configured resource allocations. The one or more resource allocations (to be activated or deactivated) are of the plurality of pre-configured resource allocations.

Optionally, the one or more user devices may share a common resource configuration. Thus, the network device may be configured to send a common resource configuration to the one or more user devices. Alternatively, the one or more user devices each may be configured with a dedicated resource configuration. Thus, the network device may be configured to send a dedicated resource configuration to each user device. This is not limited in this disclosure.

In a further implementation form of the first aspect, the one or more resource configurations may comprise one or more SPS configurations. Each SPS configuration is indicative of a plurality of semi-persistent resource allocations as the plurality of pre-configured resource allocations.

A second aspect of this disclosure provides a user device for wireless communications. The user device is configured to receive an LP-WUS from a network device. The LP-WUS comprises activation information or deactivation information (dedicated to the user device). The user device is further configured to activate or deactivate one or more resource allocations according to the activation information or deactivation information.

Optionally, activating the one or more resource allocations may be referred to as utilizing the one or more resource allocations for communication with a further device (e.g., DL and/or UL and/or D2D communications). The further device may be the network device sending the LP-WUS, or a further network device, or a further user device. Deactivating the one or more resource allocations may be referred to as not utilizing resources indicated by the one or more resource allocations.

In an implementation form of the second aspect, the activation information or deactivation information may comprise flag information indicating whether a corresponding resource allocation is activated or deactivated for the user device.

In a further implementation form of the second aspect, the activation information or deactivation information may comprise resource indication information indicating the one or more resource allocations to be activated or deactivated.

In a further implementation form of the second aspect, before receiving the LP-WUS, the user device may be configured to receive LP-WUS configuration information from the network device. The LP-WUS configuration information is indicative of one or more default resource allocations as the one or more resource allocations to be activated or deactivated.

In a further implementation form of the second aspect, before receiving the LP-WUS, the user device may be configured to receive a resource configuration from the network device. The resource configuration is indicative of a plurality of pre-configured resource allocations, and the one or more resource allocations are of the plurality of pre-configured resource allocations.

In a further implementation form of the second aspect, the one or more resource configurations may comprise one or more SPS configurations. Each SPS configuration is indicative of a plurality of semi-persistent resource allocations as the plurality of pre-configured resource allocations.

The user device of the second aspect may share the corresponding optional features and achieve the same advantages of the network device of the first aspect.

A third aspect of this disclosure provides a system. The system comprises at least one network device according to the first aspect or any implementation form thereof, and one or more user devices according to the second aspect or any implementation form thereof.

A fourth aspect of this disclosure provides a method for wireless communications. The method comprises the following steps:
generating, by a network device, a low-power wake-up signal, LP-WUS, in which the LP-WUS comprises activation information or deactivation information for activating or deactivating one or more resource allocations; and
sending, by the network device, the LP-WUS to one or more user devices.

In an implementation form of the fourth aspect, the method may further comprise activating or deactivating, by the network device, the one or more resource allocations according to the activation information or deactivation information.

In a further implementation form of the fourth aspect, the activation information or deactivation information may comprise flag information indicating whether a corresponding resource allocation is activated or deactivated for each user device.

In a further implementation form of the fourth aspect, the activation information or deactivation information may comprise resource indication information indicating the one or more resource allocations to be activated or deactivated.

In a further implementation form of the fourth aspect, before generating the LP-WUS, the method may further comprise sending, by the network device, LP-WUS configuration information to the one or more user devices. The LP-WUS configuration information is indicative of one or more default resource allocations as the one or more resource allocations to be activated or deactivated.

In a further implementation form of the fourth aspect, before generating the LP-WUS, the method may further comprise sending, by the network device, one or more resource configurations to the one or more user devices. Each resource configuration is indicative of a plurality of pre-configured resource allocations. The one or more resource allocations (to be activated or deactivated) are of the plurality of pre-configured resource allocations.

In a further implementation form of the fourth aspect, the one or more resource configurations may comprise one or more SPS configurations. Each SPS configuration is indicative of a plurality of semi-persistent resource allocations as the plurality of pre-configured resource allocations.

The method of the fourth aspect may share the same optional features and advantages as the network device of the first aspect accordingly.

A fifth aspect of this disclosure provides a method for wireless communications. The method comprises the following steps:
receiving, by a user device, a low-power wake-up signal, LP-WUS, from a network device, in which the LP-WUS comprises activation information or deactivation information; and
activating or deactivating, by the user device, one or more resource allocations according to the activation information or deactivation information.

In an implementation form of the fifth aspect, the activation information or deactivation information may comprise flag information indicating whether a corresponding resource allocation is activated or deactivated for the user device.

In a further implementation form of the fifth aspect, the activation information or deactivation information may comprise resource indication information indicating the one or more resource allocations to be activated or deactivated.

In a further implementation form of the fifth aspect, before receiving the LP-WUS, the method may further comprise receiving, by the user device, LP-WUS configuration information from the network device. The LP-WUS configuration information is indicative of one or more default resource allocations as the one or more resource allocations to be activated or deactivated.

In a further implementation form of the fifth aspect, before receiving the LP-WUS, the method may further comprise receiving, by the user device a resource configuration from the network device. The resource configuration is indicative of a plurality of pre-configured resource allocations, and the one or more resource allocations are of the plurality of pre-configured resource allocations.

In a further implementation form of the fifth aspect, the one or more resource configurations may comprise one or more SPS configurations. Each SPS configuration is indicative of a plurality of semi-persistent resource allocations as the plurality of pre-configured resource allocations.

The method of the fifth aspect may share the same optional features and advantages as the user device of the second aspect accordingly.

A sixth aspect of the present disclosure provides a computer program comprising a program code for performing the method according to the fourth aspect or any of its implementation forms.

A seventh aspect of the present disclosure provides a computer program comprising a program code for performing the method according to the fifth aspect or any of its implementation forms.

An eighth aspect of the present disclosure provides a non-transitory storage medium storing executable program code which, when executed by a processor (or a chipset), causes the method according to the fourth aspect or any of its implementation forms to be performed.

A ninth aspect of the present disclosure provides a non-transitory storage medium storing executable program code which, when executed by a processor (or a chipset), causes the method according to the fifth aspect or any of its implementation forms to be performed.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of the present disclosure, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above-described aspects and implementation forms will be explained in the following description in relation to the enclosed drawings, in which

FIG. 1 shows an example of a user device 110 and a network device 120 according to this disclosure;

FIG. 2 shows a possible schematic structure of an LP-WUS;

FIG. 3A-3B show examples of coexistence of SPS and LP-WUS monitoring;

FIG. 4A-4B show further examples of coexistence of SPS and LP-WUS monitoring;

FIG. 5 shows a diagram of a method according to this disclosure; and

FIG. 6 shows a diagram of a further method according to this disclosure.

### DETAILED DESCRIPTION OF EMBODIMENTS

A list of key terms and their acronyms/abbreviations used in the present disclosure is given as follows: 3rd Generation Partnership Project—3GPP; Base Station—BS; Connected mode Discontinuous Reception—CDRX; Configured Grant—CG; Downlink Control Information—DCI; Dynamic Grant—DG; Downlink—DL; Discontinuous Reception—DRX; Discontinuous Transmission—DTX; gNodeB—gNB; Hybrid Automatic Repeat Request—HARQ; Low Power Wake Up Signal—LP-WUS; Low Power Wake Up Receiver—LP-WUR; New Radio—NR; Modulation and Coding Scheme—MCS; Physical Downlink Control Channel—PDCCH; Physical Downlink Shared Channel—PDSCH; power saving—PS; Physical Random Access Channel—PRACH; Radio Network Temporary Identifier—RNTI; Cell RNTI—C-RNTI; Paging RNTI—P-RNTI; Random Access—RA; Radio Resource Control—RRC; Search Space Set Group—SSSG; Semi-Persistent Scheduling—SPS; Scheduling Request—SR; Uplink Control Information—UCI; Uplink—UL; Ultra-Reliable Low Latency Communications—URLLC; User Equipment—UE; extended Reality—XR.

The present disclosure provides improvements for implementing low-power wake-up signaling in wireless communications.

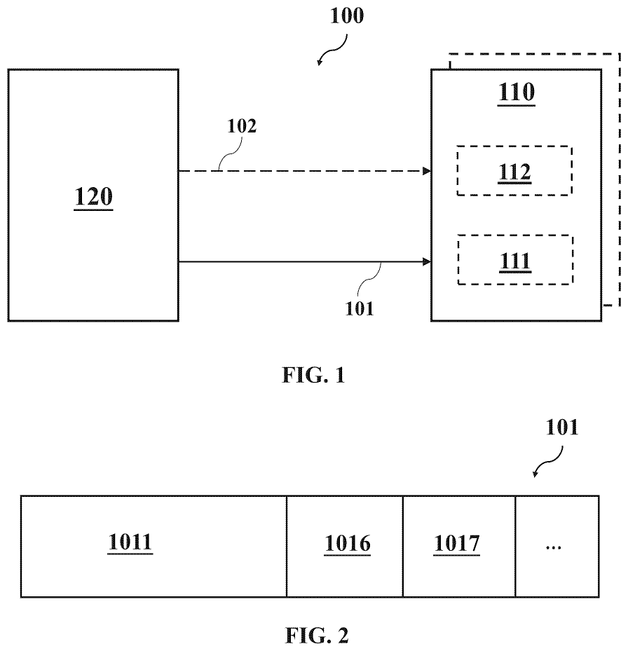

FIG. 1 shows an example of a user device 110 and a network device 120 according to the present disclosure. The user device 110 and the network device 120 may form a communications system 100. For instance, the communications system 100 may be a 5G/6G mobile communications system, or any other communications system. In the present disclosure, the user device 110 may be referred to as a UE 110, and the network device 120 may be referred to as a BS 120.

In order to save power consumption, the UE 110 may comprise a low-power wake-up receiver (LP-WUR) 111 and at least one main radio unit 112. The LP-WUR 111 may also be an ultra low-power wake-up receiver or the like. When there is no communication with the BS 120, the UE 110 may be in a low-power mode (or sleep mode). That is, the UE 110 may be adapted to switch off most of its main radio unit 112 and monitor LP-WUS 101 through its LP-WUR 111. The LP-WUS 101 may be referred to as a kind of signal that is detectable by the UE 110 (e.g., through its LP-WUR 111). The LP-WUR 111 requires a relatively low power to keep in operation. In this way, the UE 110 can save power consumption. If the UE 110 detects the LP-WUS 101 (e.g., through the LP-WUR 111), the UE 110 may be adapted to switch on its main radio unit 112 for performing communications.

In the present disclosure, the BS 120 is configured to generate an LP-WUS 101 and send the LP-WUS 101 to the UE 110. The LP-WUS 101 comprises activation information or deactivation information for activating or deactivating one or more resource allocations of the UE. The BS 120 may also send the LP-WUS 101 to a plurality of UEs. In this case, the LP-WUS 101 may comprise activation information and/or deactivation information for activating and/or deactivating one or more resource allocations of the plurality of UEs.

After receiving the LP-WUS 101, the UE 110 is configured to activate or deactivate the one or more resource allocations according to the activation information or deactivation information comprised in the LP-WUS 101. In this way, there is no need for the UE 110 to keep PDCCH monitoring when monitoring the LP-WUS 101. There is also no need for the UE 110 to look for scheduling information after being woken up by the LP-WUS 101. Instead, the UE 110 can directly perform communication using the activated one or more resource allocations. Therefore, latency can be reduced. In case of deactivation is indicated, the UE 110 can also explicitly know that it does not need to wake up and keep the sleep mode. Therefore, energy consumption can be saved.

Optionally, the activation information or deactivation information may comprise flag information indicating whether a corresponding resource allocation is activated or deactivated for each UE.

Optionally, when there are multiple UEs 110, the BS 120 may be configured to generate a common LP-WUS and broadcast the common LP-WUS to all the UEs that need to be notified. For instance, when there are multiple UEs, the LP-WUS 101 may comprise a flag (e.g., “1” or “0”) for each UE indicating whether a resource allocation is activated or deactivated. For instance, the LP-WUS 101 may comprise a three-bit field of “100” to indicate that the resource allocation is activated for the first UE (UE #1), and is not activated for the second UE or the third UE (UE #2 or UE #3).

Optionally, before generating the LP-WUS, the BS 120 may be configured to provide index information to each UE 110. The index information is used by each UE to index corresponding flag information. Optionally, the BS 120 may be configured to provide size information of the flag information to each UE. The index information and the optional size information may be provided through an RRC signalling. For instance, the BS 120 may instruct, through the RRC signalling, that UE #1 corresponds to index #1; UE #2 corresponds to index #2; UE #3 corresponds to index #3.

Alternatively, each flag in a corresponding position (or field) may be mapped to (or associated with) a corresponding UE identification, such that each UE may identify the flag of each own. For instance, the activation information and/or deactivation information may be scrambled with UE identification.

It is noted that the mapping of the (de-)activation information to each UE may utilize any method known in the field. This is not limited in this disclosure.

Alternatively, when there are multiple UEs, the BS 120 may be configured to generate, for each UE 110, a corresponding LP-WUS 101. In this case, the BS 120 is configured to send a corresponding LP-WUS to each UE, respectively. The LP-WUS 101 in this case may comprise the activation information or deactivation information without any UE identification.

Optionally, the LP-WUS 101 may comprise resource indication information indicating the one or more resource allocations to be activated or deactivated. For instance, in the example above where the resource allocation is activated for UE #1, the LP-WUS 101 may further indicate, through the resource indication information, which resource configuration is activated for UE #1. This is beneficial since there may be a plurality of resource configurations that are pre-defined or pre-configured between the BS 120 and the UE 110, and the size of the coming traffic may need more than one resource allocation. In this way, the UE 110 can explicitly know which resource configuration is activated and signalling overhead can be reduced. Moreover, the latency of the traffic can be further reduced.

Optionally, before generating the LP-WUS 101, the BS 120 may be configured to send LP-WUS configuration information 102 to the UE 110. The LP-WUS configuration information 102 may comprise necessary information for the UE 110 to monitor the LP-WUS. In the present disclosure, the LP-WUS configuration information 102 may be indicative of one or more default resource allocations to be activated or deactivated. When the LP-WUS 101 does not comprise the resource indication information, then the one or more default resource allocations are to be activated or deactivated. When the LP-WUS comprises the resource indication information, then the resource indication information overrides the one or more default resource allocations. It is noted that the indication of one or more default resource allocations to be activated or deactivated is not necessarily to be carried in the LP-WUS configuration information. Alternatively, the one or more default resource allocations to be activated or deactivated may be pre-configured by the BS 120 through other signalling (e.g., RRC signalling) or may be pre-defined as a default UE behavior (e.g., in a technical specification).

Optionally, before generating the LP-WUS 101, the BS 120 may be configured to send a resource configuration to the UE 110. The resource configuration is indicative of a plurality of pre-configured resource allocations. The one or more resource allocations (to be activated or deactivated) are of the plurality of pre-configured resource allocations. Optionally, the resource configuration is an SPS configuration, and the pre-configured resource allocations are SPS occasions (or assignments).

That is, the BS 120 may be configured to send one or more SPS configurations to the one or more UEs. Each SPS configuration is indicative of a plurality of resource allocations that are semi-persistently allocated, which may also be referred to as a plurality of SPS occasions (or assignments). In response to receiving the LP-WUS 101, the UE 110 may be configured to activate or deactivate one or more SPS occasions of the plurality of SPS occasions in accordance with the activation information or deactivation information comprised in the LP-WUS 101.

FIG. 2 shows an example of a schematic structure of an LP-WUS 101 according to the present disclosure. The LP-WUS 101 comprises a wake-up sequence 1011. The wake-up sequence 1011 may comprise a specific bit sequence that is detectable by the LP-WUR 111. Thus, the wake-up sequence 1011 is used to wake up the UE 110 (or the main radio unit 112 thereof). The LP-WUS 101 according to this disclosure may comprise activation information and/or deactivation information. The (de-)activation information may comprise flag information 1016 indicating for which UE one or more resource allocation is activated or deactivated. Optionally, the LP-WUS 101 may comprise resource indication information 1017 indicating which resource allocation(s) to activate or deactivate. The flag information 1016 and resource indication information 1017 are optional and not essential. Because when the LP-WUS is intended for one UE, the flag information 1016 and resource indication information 1017 are not necessary.

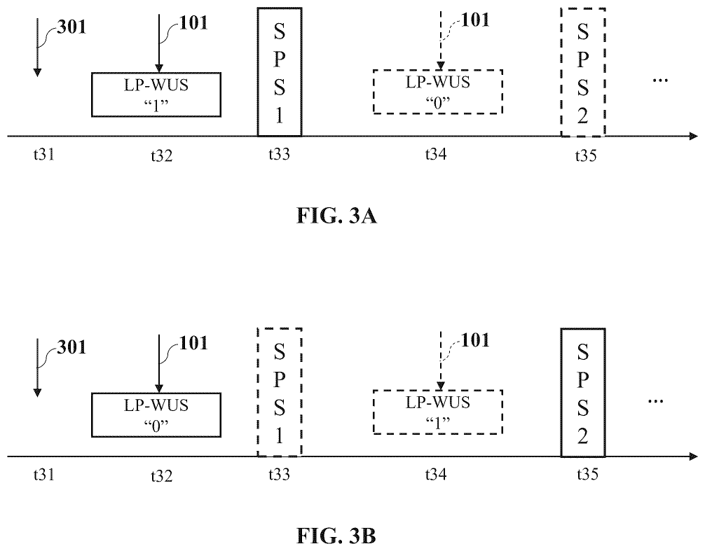

FIG. 3A shows an example of coexistence of SPS and LP-WUS monitoring. In this example, at time point t31, a BS may be configured to send an SPS configuration to a UE. The SPS configuration may be indicative of a plurality of SPS occasions, e.g., SPS 1, SPS 2, etc. In each SPS occasion, radio resources are pre-allocated or pre-configured by the network device, so that the UE may direct utilize the radio resources to perform communications (e.g., DL/UL/D2D communications). The SPS configuration may comprise (but not limited to) one or more of the following parameters: SPS interval (or periodicity), start SFN, and start subframe, which may be used to determine the plurality of SPS occasions. In the present disclosure, the UE is configured with both SPS and LP-WUS monitoring.

FIG. 3A shows an example where a default action is to skip a corresponding SPS occasion if no explicit activation information is received (via LP-WUS). For instance, at time point 32, the UE receives an LP-WUS comprising activation information. The activation information may be indicative that an SPS occasion (e.g., an SPS occasion subsequent to receiving the LP-WUS) is activated. To this end, the activation information may comprise flag information. For instance, the flag information may comprise a flag field (e.g., with a bit value of “1” or the like). Accordingly, during time period t33 of SPS occasion 1, the UE wakes up and starts communication according to SPS occasion 1. At time point t34, it is possible that the UE does not receive any LP-WUS. Accordingly, the UE does not wake up. That is, the UE keeps in sleep mode and deactivates (skips) SPS occasion 2 during time period t35. At time point t34, it is also possible that the UE receives an LP-WUS comprising deactivation information. In this case, the UE also deactivates SPS occasion 2 and does not wake up.

FIG. 3B shows a further example of coexistence of SPS and LP-WUS monitoring. FIG. 3B corresponds to FIG. 3A and shows a further example where a default action is to activate a corresponding SPS occasion if no explicit deactivation information is received (via LP-WUS). For instance, at time point 32, the UE receives an LP-WUS comprising deactivation information. The deactivation information may be indicative that an SPS occasion (e.g., an SPS occasion subsequent to receiving the LP-WUS) is deactivated. To this end, the deactivation information may comprise flag information. For instance, the flag information may comprise a flag field (e.g., with a bit value of “0” or the like). Accordingly, during time period t33 of SPS occasion 1, the UE keeps in sleep mode and deactivates SPS occasion 1. That is, the UE keeps in sleep mode and does not wake up at time point t33. At time point t34, it is possible that the UE does not receive any LP-WUS. Accordingly, the UE wakes up and activates SPS occasion 2 during time period t35. Alternatively, at time point t34, it is also possible that the UE receives an LP-WUS comprising activation information. In this case, the UE also activates SPS occasion 2 according to the activation information.

Optionally, the LP-WUS may indicate, e.g., through resource indication information, one or more specific resource allocations to activate or deactivate. For instance, in both FIG. 3A and FIG. 3B, the LP-WUS 101 may comprise resource indication information 1017 indicating one or more specific SPS occasions to be activated or deactivated. For instance, at time point t32, the LP-WUS may indicate that both SPS occasion 1 and SPS occasion 2 are activated (not shown in FIG. 3A or FIG. 3B). Accordingly, the UE activates SPS occasion 1 and SPS occasion 2 (not shown in FIG. 3A or FIG. 3B).

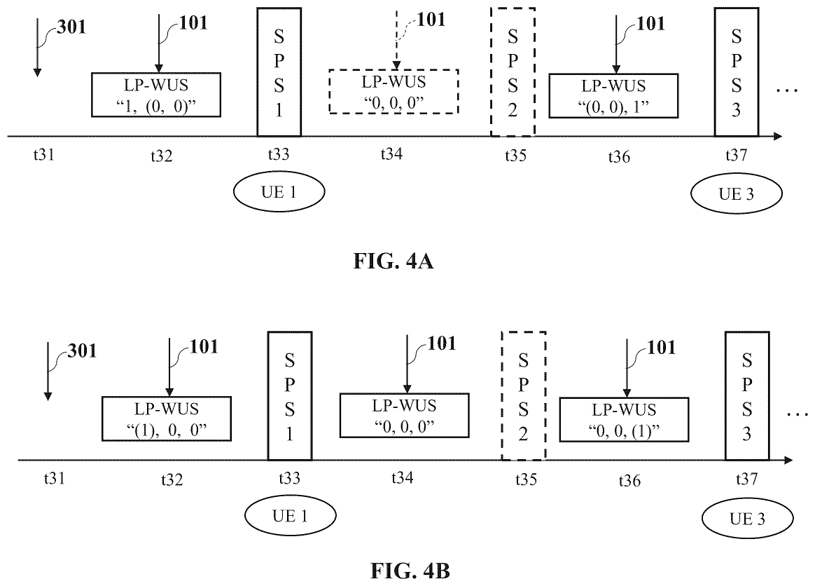

FIG. 4A shows an example of coexistence of SPS and LP-WUS monitoring. In this example, at time point t31, a BS may be configured to send one or more SPS configurations to one or more UEs (e.g., three UEs in the example of FIG. 4A). Each SPS configuration may be indicative of a plurality of SPS occasions, e.g., SPS 1, SPS 2, SPS 3, etc. In each SPS occasion, radio resources are pre-allocated or pre-configured by the network device, so that each UE may direct utilize the radio resources for communications (e.g., DL/UL/D2D communications). Each SPS configuration may comprise one or more of the following parameters: SPS interval (or periodicity), start SFN, and start subframe, which may be used to determine the plurality of SPS occasions. In this example of the present disclosure, each UE is configured with both SPS and LP-WUS monitoring.

FIG. 4A shows an example where a default action is to skip a corresponding SPS occasion if no explicit activation information is received (via LP-WUS). At time point 32, the BS generates and sends an LP-WUS comprising activation information. The activation information is indicative that an SPS occasion (e.g., an SPS occasion subsequent to receiving the LP-WUS) is activated for the first UE (i.e., UE 1) only. To this end, the activation information may comprise flag information. For instance, the flag information may comprise a flag field mapped to UE 1 indicating that the SPS occasion is activated for UE 1. For instance, the flag information may be “1, 0, 0”. Alternatively, the activation information may comprise flag information only for UE #1. That is, there is no need to carry deactivation information for the second UE (i.e., UE 2 #) or the third UE (i.e., UE #3). The “(0, 0)” in FIG. 4A denotes that the “0, 0” are optional. Accordingly, during time period t33 of SPS occasion 1, only UE #1 wakes up and starts communication according to SPS occasion 1. UE #2 and UE #3 keep in sleep mode and deactivate (or skip) SPS occasion 1.

At time point t34, it is possible that none of the three UEs receive any LP-WUS. Alternatively, an LP-WUS comprising flag information “0, 0, 0” may be generated by the device and sent to the UEs. In either case, all the UEs do not wake up. That is, the three UEs keep in sleep mode and deactivate (or skip) SPS occasion 2 during time period t35.

At time point t36, similar to time point t32, the BS generates and sends a (further) LP-WUS comprising activation information. The activation information (e.g, “0, 0, 1”) is indicative that an SPS occasion (e.g., an SPS occasion subsequent to receiving the LP-WUS) is activated for the third UE only. It is not necessary to indicate “0, 0” to UE #1 and UE #2. Accordingly, during time period t37 of SPS occasion 3, only UE #3 wakes up and activates SPS occasion 3. UE #1 and UE #2 keep in sleep mode and deactivate SPS occasion 3.

FIG. 4B shows a further example of coexistence of SPS and LP-WUS monitoring. FIG. 4B corresponds to FIG. 4A and shows a further example where a default action is to activate a corresponding SPS occasion if no explicit deactivation information is received (via LP-WUS). Different from FIG. 4A, in the case of FIG. 4B, only the deactivation information needs to be explicitly signaled through the LP-WUS. The activation information are optional. Other details are similar to those of FIG. 4A and are not repeated herein.

In FIGS. 3A, 3B, 4A, and 4B, the bit values of “1” and “0” are given for illustration purposes only. Other representations are not precluded. In general, a wakeup flag may be used (e.g., comprised in an LP-WUS) for activating a resource allocation; a skip (or continue sleeping) flag may be used (e.g., comprised in an LP-WUS) for deactivating a resource allocation.

The SPS occasions in FIGS. 3A, 3B, 4A, and 4B are given for illustration purposes only. It shall be understood that the features disclosed in FIGS. 3A, 3B, 4A, and 4B may be applied to any other types of resource allocations.

The number of UEs in FIGS. 3A, 3B, 4A, and 4B are given for illustration purposes only. It shall be understood that this disclosure may be applied to any number of UE(s).

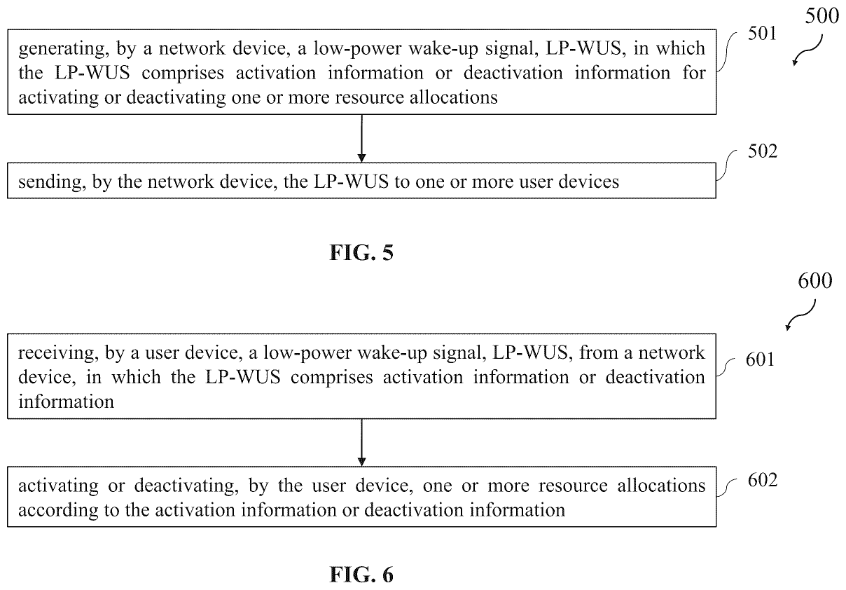

FIG. 5 shows a diagram of a method 500 according to the present disclosure. The method 500 is performed by a network device for wireless communications.

The method 500 comprises the following steps:

step 501: generating, by the network device, a low-power wake-up signal, LP-WUS, in which the LP-WUS comprises activation information or deactivation information for activating or deactivating one or more resource allocations; and

step 502: sending, by the network device, the LP-WUS to one or more user devices. The steps of the method 500 may share the same functions and details from the perspective of the network device shown in the FIGS. 1-4 described above. Therefore, the corresponding method implementations are not described again at this point.

FIG. 6 shows a diagram of a further method 600 according to the present disclosure. The method 600 is performed by a user device for wireless communications.

The method 600 comprises the following steps:
step 601: receiving, by the user device, a low-power wake-up signal, LP-WUS, from a network device, in which the LP-WUS comprises activation information or deactivation information; and
step 602: activating or deactivating, by the user device, one or more resource allocations according to the activation information or deactivation information. The steps of the method 600 may share the same functions and details from the perspective of the user device shown in the FIGS. 1-4 described above. Therefore, the corresponding method implementations are not described again at this point.

In general, this disclosure provides an LP-WUS that comprises activation information (e.g., wakeup flag(s)) and/or deactivation information (e.g., skipping flag(s)) for activating and/or deactivating (or skipping) resource occasion(s). In this way, there is no need for a UE to receive further scheduling information or to perform PDCCH monitoring. Latency can be shortened. The requirement of delay-sensitive services such as URLLC applications can be fulfilled.

Optionally, the activation information may be scrambled with UE identification, such that each UE may detect a corresponding activation information. In general, the activation information and UE information may be mapped using any suitable means such that each UE may detect a corresponding activation information (if carried) in the LP-WUS. This is not limited in this disclosure.

In a first default option, a UE may be configured to, by default, skip SPS assignment(s) when LP-WUS monitoring is activated. This configuration may be provided through an RRC configuration message. With L1 activation, one or more UEs may be assigned with the same active BWP and with the same resource allocations (e.g., SPS assignments). Optionally, the one or more UEs may be assigned with the same LP-WUS monitoring pattern.

When the one or more UEs start LP-WUS monitoring, the resource allocations (e.g., SPS the assignments) are to be deactivated (or skipped) unless the LP-WUS comprises the activation information. Optionally, a mapping between LP-WUS monitoring pattern and SPS occasions may be pre-configured (e.g., through BS) or defined as a default behaviour (e.g., by a specification). For instance, a UE may be pre-configured or defined to activate the first SPS occasion upon receiving an LP-WUS comprising the activation information. In other words, the first SPS occasion upon receiving the LP-WUS is the next SPS occasion subsequent to the received LP-WUS. Alternatively, other options are also possible and are not precluded in this disclosure. For instance, the UE may be pre-configured to activate the first two SPS occasions upon receiving the LP-WUS. It is also possible for the LP-WUS 101 to carry explicit resource indication information 1017 indicating which resource allocations (e.g., SPS occasions) to activate. This is not limited in this disclosure.

Optionally, for (de-)activating the LP-WUS monitoring, RRC signalling or L1/L2 signalling may be used. Alternatively, the LP-WUS monitoring may be (de-)activated based on timer(s) or common procedures like BWP switching, SSSG switching, and etc.

Optionally, the LP-WUS comprising the activation information and/or deactivation information may be combined or separated with an LP-WUS comprising scheduling information (e.g., PDCCH scheduling information). For instance, a single LP-WUS may comprise both of the activation information (and/or deactivation information) and PDCCH scheduling information. Alternatively, a BS may send a first type of LP-WUS comprising the activation information (or deactivation information) to a first UE, and send a second type of LP-WUS comprising PDCCH scheduling information to a second UE. This is not limited in this disclosure.

In a second default option (which is alternatively to the first default option), a UE may be configured to, by default, not skip SPS assignment(s) unless deactivation information (e.g., a skipping flag or sleeping flag) is received through the LP-WUS. In the second default option, the LP-WUS may be used to explicitly instruct the UE to continue sleeping. This is beneficial since when the UE has pre-configured resource allocations (e.g., SPS assignment(s), the UE can continue sleeping (e.g., when there is no actual data transmission needed). In this way, power consumption can be saved. The second default option may share similar option features of the first default option, which are not repeated herein.

Whether to follow the first default option or the second default option may be configured by the network. For instance, the network device of this disclosure may send default behavior information to each UE. The default behavior information is indicative of the first default option or the second default option. The first default option and the second default option may be indexed by a flag, or one or more bits, of which the meaning may be pre-defined, e.g., in a technical specification. The default behavior information may be signalled through any suitable signalling, such as but not limited to RRC signalling, or SPS configuration, or LP-WUS configuration information, or the like.

In summary, the present disclosure provides improved LP-WUS signalling. The LP-WUS comprises activation information and/or deactivation information for activating and/or deactivating one or more resource allocations. In this way, the latency can be reduced and UE power consumption can be saved. Signalling overhead can also be reduced.

The present disclosure may be applied to any telecommunications networks/systems, such as but not limited to 5G (or NR), 6G mobile networks, and the like. The network device 120 and the user device 110 in this disclosure each may comprise processing circuitry or a chipset (not shown) configured to respectively perform, conduct or initiate the various operations described herein. The processing circuitry may comprise hardware and software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. Optionally, the processing circuitry (or the chipset) comprises one or more processors and a non-transitory memory connected to the one or more processors. The non-transitory memory may carry executable program code which, when executed by the one or more processors, causes the devices to perform, conduct or initiate the operations or methods described herein.

The present invention has been described in conjunction with various embodiments as examples as well as implementations. However, other variations can be understood and effected by those persons skilled in the art and practicing the claimed invention, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. An apparatus, comprising:
one or more processors in communications with a non-transitory memory storing computer instructions, wherein the instructions, when executed by the one or more processors, cause the apparatus to:
generate a low-power wake-up signal (LP-WUS), wherein the LP-WUS comprises activation information or deactivation information for activating or deactivating one or more resource allocations; and
send the LP-WUS.

2. The apparatus according to claim 1, wherein the instructions, when executed by the one or more processors, further cause the apparatus to:
activate or deactivate the one or more resource allocations according to the activation information or deactivation information.

3. The apparatus according to claim 1, wherein the activation information or deactivation information comprises flag information indicating whether a corresponding resource allocation is activated or deactivated for each user device.

4. The apparatus according to claim 1, wherein the activation information or deactivation information comprises resource indication information indicating the one or more resource allocations to be activated or deactivated.

5. The apparatus according to claim 1, wherein before generating the LP-WUS, the instructions, when executed by the one or more processors, further cause the apparatus to:
send LP-WUS configuration information, wherein the LP-WUS configuration information is indicative of one or more default resource allocations as the one or more resource allocations to be activated or deactivated.

6. The apparatus according to claim 1, wherein before generating the LP-WUS, the instructions, when executed by the one or more processors, further cause the apparatus to:
send one or more resource configurations, wherein each resource configuration is indicative of a plurality of pre-configured resource allocations, and the one or more resource allocations are of the plurality of pre-configured resource allocations.

7. The apparatus according to claim 6, wherein the one or more resource configurations comprise one or more semi-persistent scheduling (SPS) configurations, wherein each SPS configuration is indicative of a plurality of semi-persistent resource allocations as the plurality of pre-configured resource allocations.

8. An apparatus, comprising:
one or more processors in communications with a non-transitory memory storing computer instructions, wherein the instructions, when executed by the one or more processors, cause the apparatus to:
receive a low-power wake-up signal (LP-WUS), wherein the LP-WUS comprises activation information or deactivation information; and
activate or deactivate one or more resource allocations according to the activation information or deactivation information.

9. The apparatus according to claim 8, wherein the activation information or deactivation information comprises flag information indicating whether a corresponding resource allocation is activated or deactivated for a user device.

10. The apparatus according to claim 8, wherein the activation information or deactivation information comprises resource indication information indicating the one or more resource allocations to be activated or deactivated.

11. The apparatus according to claim 8, wherein before receiving the LP-WUS, the instructions, when executed by the one or more processors, further cause the apparatus to:
receive LP-WUS configuration information, wherein the LP-WUS configuration information is indicative of one or more default resource allocations as the one or more resource allocations to be activated or deactivated.

12. The apparatus according to claim 8, wherein before receiving the LP-WUS, the instructions, when executed by the one or more processors, further cause the apparatus to:
receive a resource configuration, wherein the resource configuration is indicative of a plurality of pre-configured resource allocations, and the one or more resource allocations are of the plurality of pre-configured resource allocations.

13. The apparatus according to claim 12, wherein the one or more resource configurations comprise one or more semi-persistent scheduling (SPS) configurations, wherein each SPS configuration is indicative of a plurality of semi-persistent resource allocations as the plurality of pre-configured resource allocations.

14. The apparatus according to claim 8, wherein the apparatus is a user device or a chip in a user device.

15. A method for wireless communications, comprising:
receiving a low-power wake-up signal (LP-WUS), wherein the LP-WUS comprises activation information or deactivation information; and
activating or deactivating one or more resource allocations according to the activation information or deactivation information.

16. The method according to claim 15, wherein the activation information or deactivation information comprises flag information indicating whether a corresponding resource allocation is activated or deactivated for a user device.

17. The method according to claim 15, wherein the activation information or deactivation information comprises resource indication information indicating the one or more resource allocations to be activated or deactivated.

18. The method according to claim 15, wherein before receiving the LP-WUS, the method further comprises:
receiving LP-WUS configuration information, wherein the LP-WUS configuration information is indicative of one or more default resource allocations as the one or more resource allocations to be activated or deactivated.

19. The method according to claim 15, wherein before receiving the LP-WUS, the method further comprises:
receiving a resource configuration, wherein the resource configuration is indicative of a plurality of pre-configured resource allocations, and the one or more resource allocations are of the plurality of pre-configured resource allocations.

20. The method according to claim 19, wherein the one or more resource configurations comprise one or more semi-persistent scheduling (SPS) configurations, wherein each SPS configuration is indicative of a plurality of semi-persistent resource allocations as the plurality of pre-configured resource allocations.
